(19) United States
(12) Patent Application Publication
(10) Pub. No.: US 2026/0125587 A1
(43) Pub. Date: May 7, 2026

(54) PROCESS FOR PRODUCING A STORAGE-STABLE ACTIVATOR FOR GLASS AND CERAMIC SUBSTRATES

(71) Applicant: SIKA TECHNOLOGY AG, Baar (CH)

(72) Inventors: Michael SCHLUMPF, Stallikon (CH); Nicole KUBE, Unterengstringen (CH)

(73) Assignee: SIKA TECHNOLOGY AG, Baar (CH)

(21) Appl. No.: 19/103,304

(22) PCT Filed: Aug. 16, 2023
(86) PCT No.: PCT/EP2023/072619

§ 371 Date: Feb. 12, 2025

(30) Foreign Application Priority Data
Sep. 6, 2022 (EP) 22194034.9

(51) Int. Cl. C09J 183/08; C08G 77/08; C08G 77/26; C09J 5/02; C09J 175/04

(52) U.S. Cl. CPC C09J 183/08; C08G 77/08; C08G 77/26; C09J 5/02; C09J 175/04; C09J 2400/146; C09J 2475/00; C09J 2483/00

(57) ABSTRACT

The invention relates to a process for preparing an adhesion-promoting pre-treatment composition, comprising the steps: a) providing a reaction vessel containing 100 parts by weight of an alcohol having 1 to 4 carbon atoms; b) adding at least one organosilane OS in an amount that between 0.15 and 0.8 parts by weight of silicon are added and optionally adding at least one organoitianate OT in an amount that between 0.01 and 0.8 parts by weight of titanium are added and optionally adding at least one organozirconate OZ in an amount that between 0.01 and 0.8 parts by weight of zirconium are added; c) adding an acid A in an amount that the resulting pH is between 3.5 and 7; d) adding water, wherein the amount of water added is at least equimolar to or in a molar excess to the molar amount of hydrolyzable silicon-, titanium-, and or zirconium-bound groups present in all added organosilane OS, organoitianate OT, and organozirconate OZ, wherein the amount of water is at most 25 parts per weight; e) optionally, adding further additives selected from colorants, UV markers, condensation catalysts, or stabilizers; f) waiting, optionally under stirring, shaking, and/or heating, until all hydrolyzable groups present in all added organosilane OS, organoitianate OT, and organozirconate OZ are hydrolyzed. The process yields a highly storage-stable adhesion-promoting pre-treatment composition that is useful for automotive glass replacement operations regardless of the ambient climate and enables long-lasting adhesive bonds with improved water stability.

### TECHNICAL FIELD

The invention relates to a process for preparing an adhesion-promoting pre-treatment composition, which is suitable as adhesion promoting activator, in particular for glass and ceramic substrates, as well as the composition itself and to the use thereof.

### PRIOR ART

Adhesive bonding of substrates using adhesives such as polyurethanes is a widely used technique in construction and manufacturing. However, some substrates (bonding substrates) can be problematic in this regard since they are unable to build up sufficient initial adhesion with certain adhesives, or there is loss of adhesion overtime, particularly under demanding environmental conditions such as heat or humidity. Adhesion promoter compositions, also called activators, that are applied to such problematic substrates before the adhesive in order to form an interlayer between the substrate and the adhesive or to generate covalently bound chemical bonding moieties for the adhesive to react onto have long been used for that reason, with the goal to improve adhesion or to maintain a proper adhesion over the lifetime of the adhesively bonded article. A particularly important field of use of adhesion promoter compositions is automotive glass repair (AGR), since these applications involve difficult to bond substrates such as glass and ceramics, which often do not easily bond with the commonly used adhesives for this application, in particular those based on polyurethanes, which are most commonly used in this field. Furthermore, especially in AGR applications, the bonding process is often done under unfavorable conditions, e.g., cold or humid climate, yet it is always desired that the adhesive bond is formed as quickly and as durable as possible.

Typically, such adhesion-promoting compositions are organic or aqueous solutions containing dispersed or dissolved organosilanes, which enable an ideal interlayer or at least covalently attached reactive groups for bonds of glasses and ceramics and curable adhesives once the latter have been deposited and crosslinked on the substrates's surface. More particularly, such adhesion promoter compositions are used as primers and activators, i.e., as adhesion-promoting undercoat or adhesion-promoting cleaning compositions. Such compositions frequently contain inert, readily volatile solvents in order to assure rapid flash-off (evaporation of the solvent). However, the content of organic solvent is disadvantageous in terms of environmental compatibility and occupational safety. Furthermore, when using solvent-based silane-containing pre-treatment compositions, it is generally required to add significant amounts of silane hydrolysis- and condensation-catalysts to these compositions in order to ensure a sufficiently fast reaction of these silanes on the substrates. This, however, severely impairs the storage and handling stability of such compositions, as small amounts of humidity entering the composition's container readily leads to undesired precipitations and gelation reactions.

Aqueous adhesion promoter compositions based on organosilanes and containing water as solvent are known as EHS-friendly alternatives to solvent-based such compositions. They furthermore are clearly not sensitive to hydrolysis caused by contact with additional water and can be easily handled. However, they also have some significant disadvantages. A problem with silane-based aqueous adhesion promoter compositions is that they have either relatively low storage stability (shelf-life) coupled with adequate reactivity or inadequate reactivity coupled with adequate storage stability. This is because the silanes used have hydrolyzable functional groups that are hydrolyzed on mixing with water to form silanol groups (Si—OH). Such silanol groups are frequently reactive and condense spontaneously with one another under formation of condensation products of relatively high molecular weight, which leads to insoluble precipitates in the adhesion promoter compositions and impairment of their function.

In addition, the use of aminosilanes and/or mercaptosilanes in such aqueous adhesion promoter compositions is known. The emulsifying of mercaptosilanes or oligosilane-mercaptosilane mixtures in water is particularly difficult since the mercaptosilanes are not water-soluble before the silane groups are hydrolyzed. In order to bring these silanes into water, prior to the hydrolysis, complete homogeneous distribution has to be assured. In addition, the pH has to be adjusted with acids, for example acetic acid, such that the condensation that occurs as a further reaction is slowed as far as possible. Therefore, the silanes and the water have to be rapidly mixed homogeneously, which requires special mixing apparatuses.

The effect of this is that aqueous adhesion promoter compositions are generally sold as 2-component systems (e.g., Sika HydroPrep®-100 from Sika Schweiz AG) and a mixing process for the mixing of the two components is required on site prior to use. It is important that the two components are very rapidly mixed homogeneously with very significant turbulence. A specially developed piece of equipment (“shaker”) is required for the purpose. After the formulation, the ready-mixed product has a storage stability (“pot life”) of not more than 30 days.

Another aqueous primer composition is disclosed in WO2013/116004. This composition combines both organosilanes and organotitanates, which further improves the adhesion-promoting performance on certain substrates compared to compositions based on silanes alone. However, a combination of organosilanes and organotitanates in a one-component aqueous composition creates especially demanding conditions regarding the solution storage stability, as irreversible precipitations and agglomerations of the silanes and titanates or reaction products thereof are readily observed. By using significant amounts of stabilizing surfactants, as taught in WO2013/116004, stable solutions with lasting transparency and no precipitations can be obtained. However, such high amounts of surfactants often lead to other problems, similar to the emulsifiers described further above, such as migration of these substances onto or into the substrate surface, interference with the adhesion process or the adhesive itself, or creating of later adhesion loss by chemical reactions within the adhesive or with the substrate.

A further major drawback of water-based pre-treatment compositions is their limitation regarding application temperature. At temperatures of 0° C. or below, water-based pre-treatment compositions cannot be used anymore since the evaporation of water is severely limited and they even may freeze solid.

Solvent-based activators based on silanes and optionally titanates and/or zirconates are for example disclosed in WO2008/061981. The adhesion-promoting compositions disclosed in this document are especially suitable for low temperature applications, down to 0° or even sub-zero temperatures. However, the hydrolysis and crosslinking reactions of the active silane and further ingredients contained therein requires water, which normally stems from air humidity or water adsorbed on the substrate surface and thus proceeds quite slow. In order to accelerate this, large amounts of catalysts for these reactions are commonly added, which however in turn leads to a significant sensitivity to moisture and to a highly decreased storage stability, especially once the container of the composition is opened. Furthermore, most solvents used in solvent-based activators are VOCs and/or problematic in terms of EHS.

Furthermore, solvent-based activators often show loss of adhesion when the adhesive bond is severely exposed to water.

WO 2006/049368 A1 discloses a coating composition for improvement of anti-soiling and weatherability of a substrate. The composition is based on a blend of different organosilanes and metal oxides, isopropanol and acetic acid, a silicone-acryl-based polymer, water, and an organic solvent comprising different alcohols.

Thus, it would be desirable to have an adhesion-promoting pre-treatment composition that can be produced as consumer-friendly single-component composition in a simple process using readily available raw materials and not requiring moisture protection during production. It would be desirable to use such a composition in hot and cold climates without limitation. Furthermore, it would be desirable that such a composition is fully storage stable for months up to years with no precipitations or discolorations, even when its container is repeatedly exposed to air, and yet shows excellent adhesion-promoting performance, especially for AGR application, and a beneficial EHS profile. Additionally, the adhesive bond formed with such a composition should have excellent resistance towards water immersion.

### SUMMARY OF THE INVENTION

It is therefore an object of the present invention to provide a simple process for preparing highly storage-stable, silane- and optionally titanate-based adhesion-promoting pre-treatment compositions that are not sensitive to moisture, and that are obtainable as ready-to-use one-component compositions, and that are EHS-friendly, and that are compatible with slow- or fast-curing polyurethane adhesives, and that can be applied in any climate including hot, humid, or cold environments down to temperatures well below 0° C., that are able to form adhesive bonds not sensitive to water, and that nevertheless show excellent and long-lasting adhesion-promoting performance even after long storage and exposure to air.

It has now been found that, surprisingly, achieving this object is possible by a stepwise approach as defined in claim 1 of adding the required ingredients to an alcohol having 1 to 4 carbon atoms, preferably ethanol, as, in particular only, solvent and pre-hydrolyzing the active ingredients, thus producing an extremely storage-stable, one-component adhesion-promoting pre-treatment composition that does not show precipitations or other deteriorations even after repeated exposure to air and humidity and that maintains both its composition stability and its adhesion-promoting properties after prolonged storage of up to several months, or longer. The simple and cost-efficient process of the invention does not require special equipment and can be successfully performed using inexpensive and widely available raw materials.

The adhesion-promoting composition obtained with the process of this invention is a highly effective, adhesion-promoting pre-treatment for adhesive bonding operations, in particular when using an adhesive based on polyurethane polymers or polymers having reactive silane groups, and especially on substrates including glass or ceramics.

Surprisingly, the adhesion-promoting composition produced by the process of the invention equals or even exceeds water-based or solvent-based adhesion promoters of the state of the art in terms of adhesion-promoting capability and resistance to water, and it does not lose its adhesion-promoting performance after prolonged storage or even exposure to moisture or air.

Accordingly, the invention relates to a process for preparing an adhesion promoting pre-treatment composition, comprising the steps:
a) providing a reaction vessel containing 100 parts by weight of an alcohol having 1 to 4 carbon atoms, in particular ethanol;
b) adding at least one organosilane OS in an amount that between 0.15 and 0.8 parts by weight of silicon are added and optionally adding at least one organotitanate OT in an amount that between 0.01 and 0.8 parts by weight of titanium are added and optionally adding at least one organozirconate OZ in an amount that between 0.01 and 0.8 parts by weight of zirconium are added;
c) adding an acid A, in particular acetic acid, in an amount that the resulting pH is between 3.5 and 7;
d) adding water, wherein the amount of water added is at least equimolar to or in a molar excess to the molar amount of hydrolyzable silicon-, titanium-, and or zirconium-bound groups present in all added organosilane OS, organoitianate OT, and organozirconate OZ, wherein the amount of water is at most 25 parts per weight;
e) optionally, adding further additives selected from colorants, UV markers, condensation catalysts, or stabilizers;
f) waiting, optionally under stirring, shaking, and/or heating, until all hydrolysable groups present in all added organosilane OS, organoitianate OT, and organozirconate OZ are hydrolyzed.

It has been found that, surprisingly, it is possible with the simple process of the invention to produce lastingly storage-stable, robust solutions of pre-hydrolyzed organosilanes, organotitanates, and/or organozirconates in an ethanol-based composition that is highly suitable as adhesion-promoter or activator for adhesive bonding operations, especially involving glass or ceramic substrates. The composition obtained by the process of the invention combines all advantages of water-based and solvent-based silane-, titanate-, or zirconate-based such pre-treatment compositions but does not suffer from the respective intrinsic disadvantages commonly found in water-based or solvent-based pre-treatment compositions. An additional, astonishing finding is that the compositions of the present invention do not deteriorate or lose their adhesion-promoting effect even after prolonged storage and exposure to moist air. The compositions according to the invention nevertheless show excellent adhesion-promoting performance and are even compatible with fast-curing or accelerated adhesives, independent of the climatic conditions during application.

The adhesion-promoting pre-treatment composition of the invention is quite generally suitable as a reactive, cleaning and bonding pre-treatment for substrates, especially glass and glass ceramics, in particular for automotive glass repair or for direct glazing in automobile assembly as a pre-treatment for the adhesive bond, especially with polyurethane adhesives or adhesives based on silane-functional polymers including RTV silicones and organic silane-functional polymers, preferably one-component polyurethane or silane-curing adhesives.

### Ways of Executing the Invention

In the present document, the terms “silane” and “organosilane” refer to compounds that firstly have at least one hydrolyzable group, typically two or three hydrolyzable groups, preferably alkoxy groups or acyloxy groups bonded directly to the silicon atom via Si—O bonds, and secondly in particular have at least one organic radical bonded directly to the silicon atom via a Si—C bond. Such silanes having alkoxy or acyloxy groups are also known to the person skilled in the art as organoalkoxysilanes or organoacyloxysilanes.

The silanes have the property of undergoing hydrolysis on contact with moisture. This forms organosilanols, i.e., organosilicon compounds containing one or more silanol groups (Si—OH groups) and, through subsequent condensation reactions, organosiloxanes, i.e., organosilicon compounds containing one or more siloxane groups (Si—O—Si groups). “Epoxysilanes”, “aminosilanes” and “mercaptosilanes” refer to organosilanes wherein the organic radical respectively has an epoxy group, an amino group and a mercapto group. Organosilicon compounds having amino, mercapto or oxirane groups are also referred to as “aminosilanes”, “mercaptosilanes” or “epoxysilanes”.

“Primary aminosilanes” refer to aminosilanes having a primary amino group, i.e., an NH₂ group bonded to an organic radical. “Secondary aminosilanes” refer to aminosilanes having a secondary amino group, i.e., an NH group bonded to two organic radicals.

An Si-bonded hydrolyzable group is a group that can be hydrolyzed by hydrolysis to a silanol group, optionally in the presence of a catalyst. Hydrolysis products are silanes wherein the hydrolyzable groups have been at least partly hydrolyzed, i.e., at least some of the hydrolyzable groups have been replaced by an OH group. Condensation products include condensates of two or more hydrolyzed silanes of this kind. These hydrolysis and condensation products of silanes are known to the person skilled in the art.

The expression “independently” here always also means independently within the same molecule if there are different options.

A substance or composition is referred to as “storage-stable” or “storable” when it can be stored at room temperature in a suitable container over a prolonged period, typically over at least 3 months to up to 6 months or more, without any change in its application or use properties to a degree of relevance for the use thereof as a result of the storage.

The terms “mass” and “weight” are used synonymously in this document. Thus a “percentage by weight” (% by weight) is a percentage mass fraction which unless otherwise stated relates to the mass (the weight) of the total composition or, depending on the context, of the entire molecule.

“Room temperature” refers to a temperature of 23±2° C., especially 23° C.

All industry standards and official standards mentioned in this document, unless stated otherwise, relate to the version valid at the time of filing of the first application.

The invention relates in a first aspect to a process for preparing an adhesion promoting pre-treatment composition, comprising the steps:
a) providing a reaction vessel containing 100 parts by weight of an alcohol having 1 to 4 carbon atoms, in particular ethanol;
b) adding at least one organosilane OS in an amount that between 0.15 and 0.8 parts by weight of silicon are added and optionally adding at least one organotitanate OT in an amount that between 0.01 and 0.8 parts by weight of titanium are added and optionally adding at least one organozirconate OZ in an amount that between 0.01 and 0.8 parts by weight of zirconium are added;
c) adding an acid A, in particular acetic acid, in an amount that the resulting pH is between 3.5 and 7;
d) adding water, wherein the amount of water added is at least equimolar to or in a molar excess to the molar amount of hydrolyzable silicon-, titanium-, and or zirconium-bound groups present in all added organosilane OS, organoitianate OT, and organozirconate OZ, wherein the amount of water is at most 25 parts per weight;
e) optionally, adding further additives selected from colorants, UV markers, condensation catalysts, or stabilizers;
f) waiting, optionally under stirring, shaking, and/or heating, until all hydrolysable groups present in all added organosilane OS, organoitianate OT, and organozirconate OZ are hydrolyzed.

The steps above are preferably followed in consecutive order a) to f). It may be advantageous to include further steps between two respective steps, e.g., storing or transporting of the intermediate composition, or process steps such as heating, mixing, or cooling, or adding of additional ingredients.

First step a) involves providing a reaction vessel containing 100 parts by weight of an alcohol having 1 to 4 carbon atoms. These parts per weight are in relation to the other ingredients added in the subsequent steps of the process, e.g., step b) or step c).

The solvent used in step a) must be an alcohol having 1 to 4 carbon atoms. Specific examples of suitable such alcohols include methanol, ethanol, n-propanol (1-propanol), isopropanol (propane-2-ol), n-butanol (1-butanol), isobutanol (2-methy-1-propanol), sec.butanol (2-butanol), and tert.butanol (2-methy-2-propanol). Methanol, ethanol, isopropanol, and tert.butanol are preferred among those due to their advantageously low boiling points compared to the others.

Ethanol was found to be the most preferred solvent for the process of the invention, as it is able to properly dissolve all ingredients, is compatible with water, evaporates fairly quickly, and does not pose a significant EHS hazard. Additionally, ethanol is especially compatible with the substances added in step b) and enables exceptional storage stability of the composition.

Furthermore, ethanol has good cleaning and degreasing properties, which is a further advantage when the composition prepared using the process of the invention is used as activator, since it not only deposits the active, adhesion-promoting compounds on the substrate surface, but also removes unwanted depositions such as dirt, grease, and oil from the substrate.

It is preferred that said alcohol having 1 to 4 carbon atoms, preferably ethanol, is the only organic solvent used in the process of the invention and subsequently in the composition produced by this process. However, it is possible to add small amounts of co-solvents, for example in order to improve the substrate cleaning properties or to improve dissolution of certain ingredients.

Cosolvents are understood to mean ethanol-miscible organic solvents such as other alcohols, including diols, or ethers or ketones. However, it is preferable that such organic solvents are used only in a small amount, i.e. typically less than 10% by weight based on the total solvent content in the composition including ethanol. More preferably, the composition—apart from traces of alcohols that result from the hydrolysis of the alkoxysilanes used in the aqueous composition—is free of such organic cosolvents. If a co-solvent is used, the VOC problem is increased in turn, thus it is preferred that such co-solvents, if present, are not problematic in terms of EHS properties.

In is however possible and may be advantageous to add in step d) an excess of water, such that unreacted water remains in the composition as cosolvent. The maximum amount of water to be added in step d) is 25 parts by weight (to the 100 parts by weight of alcohol in step a). Preferably, the amount of water added does not exceed 20 parts by weight. Preferably, the total amount of water in the composition after step f) is at most 20% by weight, more preferably at most 15% by weight, based on the total composition.

Step b) of the process according to the invention involves adding at least one organosilane OS in an amount that between 0.15 and 0.8 parts by weight of silicon are added and optionally adding at least one organotitanate OT in an amount that between 0.01 and 0.8 parts by weight of titanium are added and optionally adding at least one organozirconate OZ in an amount that between 0.01 and 0.8 parts by weight of zirconium are added.

The amounts are to be calculated based on the added weight of silicon, optionally titanium, and optionally zirconium atoms contained in the added organosilane OS, optionally added organotitanate OT, and optionally added organozirconate OZ. With this calculation, differences between individual, e.g., organosilanes can be taken into account, as they may differ between each other with respect to their individual number of functional groups. For example, N-(2-aminoethyl)-3-aminopropyltrimethoxysilane, an organoilane OS, contains 12.63% by weight of silicon, whereas bis(trimethoxysilylpropyl)amine, another organoilane OS, contains 16.45% by weight of silicon, based on each respective molecule. The amount of silicon in both these examples determines the effective amount of active bonding ingredients much more precisely than the total weight, as the latter may vary significantly between different organosilanes.

In preferred embodiments, step b) involves adding between 1 and 5 parts by weight of at least one organosilane OS and optionally between 0.1 and 5 parts by weight of at least one organotitanate OT and optionally between 0.1 and 5 parts by weight of at least one organozirconate OZ to the ethanol provided in step a). These amounts, based on the total weight of the added molecules and not the individual Si, Ti, or Zr atoms, still encompassed the most preferred embodiments of organosilane OS, rganotitanate OT, and organozirconate OZ.

Mandatory in step b) is the at least one organosilane OS in an amount that between 0.15 and 0.8 parts by weight of silicon are added to the 100 parts per weight of said alcohol having 1 to 4 carbon atoms, preferably ethanol. Higher amounts were found to detrimentally affect storage stability of the composition while not further improving the adhesion-promoting performance.

Organosilanes OS added in step b) to the composition each have at least one Si-bonded hydrolyzable group that may already initially be partially hydrolyzed, but preferably is not. These may be any customary hydrolyzable groups, preference being given to alkoxy groups and acyloxy groups, and particular preference to C₁-C₄-alkoxy groups. After mixing with water in step d), the hydrolyzable groups can be hydrolyzed with time. The result in that case is hydrolysis products in which at least some and later all of the hydrolyzable groups are replaced by OH groups (silanol groups). As a further reaction, condensation products may form to a limited extent via the silanol groups formed in the hydrolysis products. For instance, the organosilanes present may also be in fully hydrolyzed or partly hydrolyzed or even partly condensed form. However, the acid A added in step c) will prevent extensive condensation reactions.

Particularly suitable organosilanes OS are organosilicon compounds of the formulae (I) or (II) or (III)

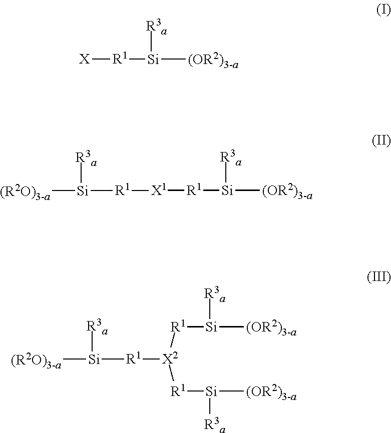

R¹ here is a linear or branched, optionally cyclic alkylene group having 1 to 20 carbon atoms, optionally having aromatic moieties, and optionally having one or more heteroatoms, especially nitrogen atoms.

R² here is H or an alkyl group having 1 to 5 carbon atoms, especially methyl or ethyl, or an acyl group, especially acetyl.

R³ here is an alkyl group having 1 to 8 carbon atoms, especially methyl.

X here is H, or is a functional group selected from the group comprising OH, (meth)acryloyloxy, mercapto, glycidoxy, epoxy, primary amine, alkylamine comprising primary and secondary amino groups, secondary alkyl or arylamine, acylthio and vinyl, preferably amine in all forms as described before. For the sake of completeness, it is mentioned that acylthio in this document is understood to mean the substituent

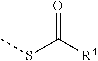

where R⁴ is alkyl, especially having 1 to 20 carbon atoms, and the dotted line represents the bond to the substituent R¹.

X¹ here is a functional group selected from the group comprising NH, S, S₂ and S₄.

X² here is a functional group selected from the group comprising N and isocyanurate.

Index a here represents one of the values 0, 1 and 2, preferably 0.

The substituent R¹ is especially a methylene, propylene, methylpropylene, butylene or dimethylbutylene group. As particularly preferred is propylene group as substituent R¹.

Examples of suitable organosilicon compounds of the formula (I) are the organosilicon compounds selected from the group comprising
octyltrimethoxysilane, dodecyltrimethoxysilane, hexadecyltrimethoxysilane, methyloctyldimethoxysilane;
3-methacryloyloxypropyltrialkoxysilanes, 3-methacryloyloxypropyltriethoxysilane, 3-methacryloyloxypropyltrimethoxysilane;
3-aminopropyltrimethoxysilane, 3-aminopropyltriethoxysilane, 3-aminopropyldimethoxymethylsilane, 3-amino-2-methylpropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, [3-(2-aminoethylamino)propyl]trimethoxysilane (=4,7,10-triazadecyltrimethoxysilane), 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane;
3-acylthiopropyltrimethoxysilane;
vinyltrimethoxysilane and vinyltriethoxysilane.

Also preferred are the organosilicon compounds just mentioned wherein the alkoxy groups are replaced by acetoxy groups, for example octyltriacetoxysilane (octyl-Si(O(O═C)CH₃)₃). Such organosilicon compounds eliminate acetic acid on hydrolysis.

Among these organosilicon compounds mentioned, preference is given to those that have an organic substituent bonded to the silicon atom which additionally have a functional group, i.e., which is not an alkyl group, and conform to a formula (I) in which X is not H.

Suitable examples of organosilicon compounds of the formula (II) are the organosilicon compounds selected from the group comprising bis[3-(trimethoxysilyl)propyl]amine, bis[3-(triethoxysilyl)propyl]amine, 4,4,15,15-tetraethoxy-3,16-dioxa-8,9,10,11-tetrathia-4-15-disilaoctadecane (bis(triethoxysilylpropyl) polysulfide or bis(triethoxysilylpropyl)tetrasulfane), bis(triethoxysilylpropyl) disulfide.

Suitable examples of organosilicon compounds of the formula (III) are the organosilicon compounds selected from the group comprising tris[3-(trimethoxysilyl)propyl]amine, tris[3-(triethoxysilyl)propyl]amine, 1,3,5-tris[3-(trimethoxysilyl)propyl]-1,3,5-triazine-2,4,6(1H,3H,5H)-trioneurea (=tris(3-(trimethoxysilyl)propyl) isocyanurate) and 1,3,5-tris[3-(triethoxysilyl)propyl]-1,3,5-triazine-2,4,6(1H,3H,5H)-trioneurea (=tris(3-(triethoxysilyl)propyl) isocyanurate).

Optionally, the composition may also comprise at least one tetraalkoxysilane of the formula (IV)

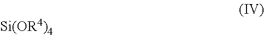

where R⁴ is independently an alkyl group having 1 to 4 carbon atoms or an acyl group, especially acetyl group. Such tetraalkoxysilanes are, for example, tetramethoxysilane, tetraethoxysilane, tetraisopropoxysilane, tetrapropoxysilane, tetrabutoxysilane and tetraacetoxysilane. Particular preference is given to tetraethoxysilane. As in the case of the aminosilanes and mercaptosilanes, tetraalkoxysilanes can undergo hydrolysis in the presence of water and optionally condense with other silanes.

Organosilane OS preferably comprises at least one organosilane or condensate thereof that has at least one Si-bonded hydrolyzable group and has at least one primary and/or secondary amino group. If more than one type of organosilane OS is to be added, the addition may be sequentially without any specific order. However, it is often also possible to add all silanes simultaneously in the form of a silane premix. These further organosilanes OS are in particular organosilanes or oligomers of these organosilanes that have at least one Si-bonded hydrolyzable group and have at least one further functional group selected from alkyl groups, alkylene groups, epoxy groups, mercapto groups, hydroxyl groups and isocyanurate groups, including the mercaptosilanes and epoxysilanes described below.

Preferred as organosilanes OS are aminosilanes, especially aminosilanes with X═NH₂ or NH₂—CH₂—CH₂—NH, X¹═NH and X²═N. Particular preference is given to 3-aminopropyltrimethoxysilane, N-(2-aminoethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane and bis[3-(triethoxysilyl)propyl]amine and mixtures thereof with one another.

Suitable aminosilanes as organosilane OS are especially aminosilanes selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, N-methyl-3-aminopropyltrimethoxysilane, N-ethyl-3-aminopropyltrimethoxysilane, N-butyl-3-aminopropyltrimethoxysilane, N-cyclohexyl-3-aminopropyltrimethoxysilane, N-phenyl-3-aminopropyltrimethoxysilane, N-methyl-3-amino-2-methylpropyltrimethoxysilane, N-ethyl-3-amino-2-methylpropyltrimethoxysilane, N-ethyl-3-aminopropyldimethoxymethylsilane, N-phenyl-4-aminobutyltrimethoxysilane, N-phenylaminomethyl-dimethoxymethylsilane, N-cyclohexylaminomethyldimethoxymethylsilane, N-methylaminomethyldimethoxymethylsilane, N-ethylaminomethyldimethoxy-methylsilane, N-propylaminomethyldimethoxymethylsilane, N-butylamino-methyldimethoxymethylsilane; N-(2-aminoethyl)-3-aminopropyltrimethoxysilane, 3-[2-(2-aminoethylamino)ethylamino]propyltrimethoxysilane, bis(trimethoxysilylpropyl)amine, and analogs thereof having three ethoxy or three isopropoxy groups rather than the three methoxy groups on the silicon.

In one embodiment, the aminosilane of the formula (I) is an aminosilane of the formula (V)

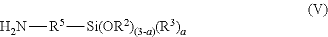

where R⁵ is a linear or branched alkylene group having 1 to 6 carbon atoms, especially propylene, and the other substituents and indices are as defined in formula (I). Particular preference is given here to 3-aminopropyltrimethoxysilane.

In a preferred embodiment, the aminosilane of the formula (I) has secondary amino groups, especially aminosilanes of the formula (VI) or (VII) or (VIII).

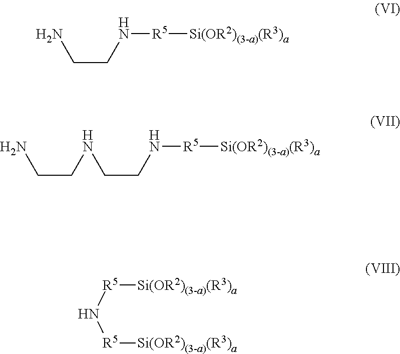

where R⁵ is a linear or branched alkylene group having 1 to 6 carbon atoms, especially propylene, and the other substituents and indices are as defined in formula (I). N-(2-Aminoethyl)-3-aminopropyltrimethoxysilane, 3-[2-(2-aminoethylamino)ethylamino]propyltrimethoxysilane and bis(trimethoxysilylpropyl)amine have been found to be particularly preferable as organosilane OS.

It has been found to be particularly advantageous when two or more aminosilanes of the formula (I) are present in the composition as organosilane OS, of which preferably at least one is an aminosilane of the formula (VI). A particularly preferred combination within organosilane OS is an aminosilane of the formula (VI) and an aminosilane of the formula (VIII) in the composition.

In one or more embodiments, the at least one aminosilane or hydrolysates thereof is present in the composition of the invention after step d) in an amount of 0.5% to 5% by weight, preferably 1% to 4% by weight, especially preferably in an amount of 2% to 3% by weight, based on the overall composition after step d).

Organosilane OS comprises in preferred embodiments at least one epoxysilane. An epoxysilane suitable as organosilane OS has at least one epoxy group, for example a glycidoxy group, and at least one Si-bonded hydrolyzable group. The epoxy group is preferably a glycidoxy or epoxycyclohexyl group, especially a glycidoxy group.

Preferred epoxysilanes are (epoxyalkoxy)alkyltrialkoxysilanes and 3-glycidoxypropyltrialkoxysilanes. Particular preference is given to gamma-glycidoxypropyltrimethoxysilane. Preferred representatives of these substance classes are beta-(3,4-epoxycyclohexyl)ethyltrimethoxysilane and beta-(3,4-epoxycyclohexyl)ethyltriethoxysilane, and also 3-glycidoxypropyltrimethoxysilane and/or 3-glycidoxypropyltriethoxysilane. More preferably, 3-glycidoxypropyltrimethoxysilane and/or 3-glycidoxypropyltriethoxysilane are used as organosilane OS.

In one or more embodiments, the at least one epoxysilane or hydrolysates thereof is present in the composition of the invention after step f) in an amount of 0.1% to 2% by weight, preferably 0.2% to 1.5% by weight, especially preferably in an amount of 0.5% to 1% by weight, based on the overall composition after step d).

Organosilane OS comprises in preferred embodiments at least one mercaptosilane.

A mercaptosilane suitable as organosilane OS has at least one mercapto group, for example a mercaptopropyl groups, and at least one Si-bonded hydrolyzable group, and is preferably a mercapto-functional organoalkoxysilane, i.e., mercaptosilane that bears a C₁ to C₄ alkoxy group on the hydrolyzable silane group. Particular preference is given to mercapto-functional organomethoxysilanes and mercapto-functional organoethoxysilanes. Mercaptosilanes having three alkoxy groups, especially three methoxy groups, have been found to be particularly advantageous.

Particularly preferred mercaptosilanes are 3-mercaptopropyltrimethoxysilane and 3-mercaptopropyltriethoxysilane and 3-mercaptopropylmethyldimethoxysilane, especially 3-mercaptopropyltrimethoxysilane and 3-mercaptopropyltriethoxysilane, more preferably 3-mercaptopropyltrimethoxysilane.

However, it is also possible to use mercaptosilanes having multiple mercapto and/or multiple silane groups as organosilane OS.

In one or more embodiments, at least one mercaptosilane or hydrolysates thereof is present in the composition of the invention after step f) in an amount of 0.1% to 2% by weight, preferably 0.15% to 1.5% by weight, especially preferably in an amount of 0.5% to 1% by weight, based on the overall composition after step d).

If organosilane OS is a mixture of different organosilanes, and if these organosilanes are not sensitive to cross reactions with each other, they may be premixed and added together in step b).

In especially preferred embodiments of the inventive process, in step b) at least one mercaptosilane and at least one aminosilane are added. This combination has especially beneficial adhesion-promoting properties while it is especially storage-stable.

By contact with water, organosilanes OS are slowly or quickly hydrolyzed during steps e) or f). Even in the best optimized procedure conditions, transient precipitation may occur, and the solution may turn slightly turbid, if the pH is correctly adjusted in step c) however, especially in the range of between 2 and 5, this incipient precipitation can be reversed completely in a short time (typically <10 min) and the solution becomes permanently transparent.

Optionally and preferably, in step b) at least one organotitanate OT in an amount that between 0.01 and 0.8 parts by weight of titanium is added.

Preferably, between 0.1 and 5 parts by weight of at least one organotitanate OT are added in step b) in addition to organosilane OS.

Organotitanate OT optionally but preferably added in step b) is in particular an alcohol-soluble, in particular ethanol-soluble, organotitanate or able to form an alcohol-soluble titanate species under acidic and/or hydrolysis conditions. Using organotitanate in pre-treatment compositions generally leads to particularly heat-stable bonds that show excellent bonding properties even below room temperature, and generally improves the adhesion-promoting properties of the resulting pre-treatment composition especially under hot weather conditions.

Suitable and preferred amounts of organotitanate OT or hydrolysates thereof within the composition are preferably between 0.1% and 4% by weight, in particular between 0.5% and 3.5% by weight, most preferably between 1% to 3% by weight of organotitanate OT, based on the overall composition after step d).

Suitable organotitanates OT are preferably those of the formula Ti(OR)₄, i.e., comprising substituents bonded via an oxygen-titanium bond, also including chelate substituents (polydentate ligands). Particularly suitable substituents bonded to the titanium atom via an oxygen-titanium bond are those substituents selected from the group comprising alkoxy group, sulfonate group, carboxylate group, aminoalkoxy group, dialkylphosphate group, dialkylpyrophosphate group and acetylacetonate group.

Particularly suitable compounds to be used as organotitanate OT are those in which all substituents bonded to the titanium are selected from the group comprising alkoxy group, sulfonate group, carboxylate group, aminoalkoxy group, dialkylphosphate group, dialkylpyrophosphate group and acetylacetonate group, where all substituents may be identical or different.

Particularly suitable alkoxy groups have been found to be especially methoxy, ethoxy, propoxy, isopropoxy, butoxy and isobutoxy substituents.

Especially preferred organotitanates OT have substituents selected from alkoxy groups, in particular isopropoxy groups, and aminoalkoxy groups, in particular 2-(2-aminoethylamino)ethoxy groups, or mixtures of these substituents.

Most preferred as organotitanate OT is a tetraalkoxytitanate, in particular tetra-n-butyl titanate or tetra-isopropyl titanate.

Suitable organotitanium compounds to be used as organotitanate OT are commercially available, for example from Kenrich Petrochemicals or DuPont.

A most preferred organotitanate OT is tetra-n-butyl titanate or tetra-isopropyl.

Optionally and preferably, in step b) at least one organozirconate OZ in an amount that between 0.01 and 0.8 parts by weight of titanium is added.

Preferably, between 0.1 and 5 parts by weight of at least one organozirconate OZ are added in step b) in addition to organosilane OS.

Organozirconate OZ is an organozirconium compound having at least one substituent bonded to the zirconium atom via an oxygen-zirconium bond.

Suitable organozirconate OZ compounds are especially those which bear at least one functional group which is selected from the group comprising alkoxy group, sulfonate group, carboxylate group, phosphate or mixtures thereof, and which is bonded directly to a zirconium atom via an oxygen-zirconium bond.

Organozirconate OZ compounds are commercially available, for example from Kenrich Petrochemicals. Preferred are tetraalkoxyzirconates, in particular tetra-n-butyl zirconate.

It is clear to the person skilled in the art that these organotitanate OT and organozirconate OZ compounds hydrolyze under the influence of water and form OH groups bonded to the titanium or zirconium atom. Such hydrolyzed or partly hydrolyzed organotitanium compounds and organozirconium compounds may then furthermore condense themselves and form condensation products which have Ti—O—Ti, Zr—O—Zr bonds. When silanes and/or titanates and/or zirconates as adhesion promoters are mixed, mixed condensation products which have Si—O—Ti, Si—O—Zr or Ti—O—Zr bonds are also possible. A small proportion of such condensation products is possible, especially when they are soluble, emulsifiable or dispersible.

Step c) of the process according to the invention involves adding an acid A in an amount that the resulting pH is between 3.5 and 7 to the mixture of alcohol, in particular ethanol, and optionally water and organosilane OS and optionally organotitanate OT and optionally organozirconate OZ.

The resulting pH of the ethanolic composition after step c) is preferably between 4 and 6.5, in particular between 4.5 and 6. It is recommended to measure the pH at this stage, e.g., by using a pH-meter or pH indicator paper, and adjust the pH within the range just specified by further addition of acid A if required. The necessary amount of acid also depends on the types and amounts of ingredients added in step b), as for example aminosilanes have alkaline functional groups that require additional acid in order to establish the required pH.

Acid A may be organic or inorganic. Organic acids A are firstly carboxylic acids, especially a carboxylic acid selected from the group comprising formic acid, acetic acid, propionic acid, trifluoroacetic acid, oxalic acid, malonic acid, succinic acid, maleic acid, fumaric acid and citric acid, and amino acids, especially aspartic acid and glutamic acid. A preferred carboxylic acid is acetic acid.

Organic acids A are secondly especially those containing a sulfur atom. Such organic acids are especially organic sulfonic acids. Organic sulfonic acid is understood to mean compounds that have an organic radical having carbon atoms and have at least one functional group —SO₃H. Preference is given to aromatic sulfonic acids.

The aromatic sulfonic acid may be mono- or polycyclic, and one or more sulfo groups may be present. For example, this may be naphthalene-1- or -2-sulfonic acid, naphthalene-1,5-disulfonic acid, benzenesulfonic acid or alkylbenzenesulfonic acids.

The acid A may also be an inorganic acid. Suitable inorganic acids A are, for example, those that have a sulfur atom or a phosphorus atom. Acids having phosphorus atoms are especially phosphoric acid, phosphorous acid, phosphonic acid, phosphonous acid. Acids having sulfur atoms are especially sulfur acids, especially sulfuric acid, sulfurous acids, persulfuric acid, disulfuric acid (=pyrosulfuric acid), disulfurous acid, dithionic acid, dithionous acid, thiosulfuric acid or thiosulfurous acid.

The highest preference is given to, especially water-soluble or at least water-miscible, acids A having a pKₐ between 4.0 and 5.0. pKₐ is understood by the chemist in a known manner to mean the negative decadic logarithm of the acid dissociation constant Kₐ: pKₐ=−log₁₀Kₐ.

Most preferred acid A is a carboxylic acid, especially a water-soluble carboxylic acid, in particular acetic acid.

Once step c) is completed, step d) can be initiated, i.e., adding water wherein the amount of water added is at least equimolar to or in a molar excess to the molar amount of hydrolyzable silicon-, titanium-, and or zirconium-bound groups present in all added organosilane OS, organoitianate OT, and organozirconate OZ, wherein the amount of water is at most 25 parts per weight.

This amount defining the lower range limit (i.e., the equimolar amount mentioned above) normally should be at least roughly calculated, based on all Si—OR, Ti—OR, and Zr—OR groups theoretically present in the composition, wherein the term —OR means a hydrolysable group on the respective Si, Ti, or Zr atom.

Calculating the proper amount is straightforward for the skilled person based on the molecular structure and the added amount of each added organosilane OS, organoitianate OT, or organozirconate OZ.

Water has to be added in an amount that enables full hydrolysis of all hydrolysable species contained in the composition. With this approach, the resulting composition is highly active as adhesion-promoting pre-treatment, including for low temperature applications, and furthermore is non-sensitive to further exposure to water coming in contact with the composition. Hydrolysis as intended generates Si—OH, Ti—OH, or Zr—OH groups within the composition, while in particular compounds with —Si(OH₃) groups and optionally but preferably Ti(OH₄) groups are in particular present, generated from the hydrolysis of trialkoxysilane-functional compounds and Ti(OR)₄ compounds, respectively.

In preferred embodiments of the process according to the invention, the composition after step f) of the process contains between 0.2% and 2.0% by weight of Si(OH)₃ groups, based on the total weight of the composition.

In preferred embodiments of the process according to the invention, the composition after step f) of the process contains between 0.05% and 1.5% by weight of Ti(OH)₄ groups, based on the total weight of the composition.

Water to be used in step d) is preferably deionized water, in particular either obtained by distillation or by reverse osmosis using common such processes known in the art.

Step d) can be done in a very easy manner and is completed in minutes. Preferably, some stirring or shaking may be employed to ensure a homogeneous mixing and the quick disappearance of possibly present temporary precipitations or turbidities.

In preferred embodiments of the process according to the invention, the amount of water added in step d) is between 0.3% and 2% by weight, based on the total composition after step d).

In other preferred embodiments of the process according to the invention, the amount of water added in step d) is between 0.3% and 15% by weight, based on the total composition after step d).

Step e) involves optionally adding further additives selected from colorants, UV markers, condensation catalysts, or stabilizers, or even other commonly added additives in activator pre-treatment compositions.

Additives added in step e) should not impair the storage stability of the composition. Common additional constituents are especially catalysts, stabilizers, surfactants, acids, dyes and pigments.

Under some circumstances, it may be advantageous that in step e) polyisocyanates or polyurethane prepolymers having isocyanate groups are added to the composition.

It has been found to be advantageous, however, that the composition of the invention is isocyanate-free, i.e., that no substances with reactive NCO groups are added in step e).

As mentioned before, step e) is fully optional. It may even be advantageous to not add further ingredients after step d), as the composition obtained after step f) but with omission of step e) is already a fully functional and highly active adhesion-promoting pretreatment and can be produced using only basic and cost-efficient ingredients while possessing all advantages of the present invention, including excellent storage stability.

Nevertheless, in preferred embodiments, a silane condensation catalyst, in particular a water-soluble tin catalyst, is added to the composition during step e). Such catalysts are known to the skilled person in the field of silane-based pre-treatment compositions. Addition of a catalyst accelerates the condensation reaction of the active ingredients once the pre-treatment composition is applied on a surface, and this may be helpful especially in cases where especially fast curing adhesives are used and/or where the ambient temperature during application is especially low. Surprisingly, addition of such catalysts does not impair the storage or handling stability of the compositions according to the invention, unlike in classical solvent-based adhesion promoters.

In an especially preferred embodiment of the process according to the invention, the composition after step e) comprises, based on the total composition:
between 80% and 95% by weight of said alcohol, in particular ethanol;
between 1% and 3.5% by weight of organosilane OS;
between 1% and 3.5% by weight of organotitanate OT;
between 0.3% and 2% by weight of acid A, in particular acetic acid;
between 0.3% and 15% by weight of water; and
optionally between 0.01% and 0.2% of a silane condensation catalyst, in particular a water-soluble tin catalyst;
wherein organosilane OS and organotitanate OT may be partially or fully hydrolyzed by the water in the composition.

Such a composition is especially handling- and storage-stable, yet especially reactive and highly performing as adhesion-promoting pre-treatment. Such a composition is especially suitable as pre-treatment in AGR applications independent of the ambient climate and the adhesive used in the process.

Another aspect of the present invention is an adhesion-promoting pre-treatment composition obtained from the process according to the invention as described above, wherein all added organosilanes OS and optionally added organotitanates OT and optionally added organozirconates OZ are fully hydrolyzed.

A further aspect of the present invention is the use of an adhesion-promoting pre-treatment composition according to the invention as adhesion promoter or activator. This aspect is discussed in particular further below.

In especially preferred embodiments of such a use according to the invention, at least one of the substrates to be treated with the adhesion-promoting pre-treatment composition is a glass or glass ceramic substrate, in particular in automotive glass repair applications.

The use according to the invention is in particular together with a polyurethane adhesive or an adhesive based on silane-functional polymers. Silane-functional polymer encompass both silicones (polydimethylsiloxanes) as well as organic silane-functional polymers, such as so-called MS polymers, silane-functional polyurethanes, and other silane-functional organic polymers.

The composition obtained with the process of the invention is in particular one-component adhesion-promoting pre-treatment composition. Used as pre-treatment in this sense, the composition improves adhesion of adhesives on substrates.

It has now been found that the adhesion-promoting pre-treatment composition of the invention can be used exceptionally efficiently for production of an adhesive undercoat on a substrate S1, the substrate temperature being low, i.e., lower than 5° C. It has additionally been found that, especially also at substrate temperatures between 0° C. and −2° C., preferably between −5° C. and −15° C., excellent adhesive undercoats can be achieved.

In a further aspect, the invention thus also relates to a process for producing a substrate S1 coated with an adhesion-promoting pre-treatment composition according to the invention, which comprises the following step:
applying adhesion-promoting pre-treatment composition as described above to a substrate S1 which in particular has a temperature of less than 5° C., especially of between 0° C. and −20° C., preferably of between −5° C. and −15° C.

Possible substrates S1 are in principle most natural or synthetic substrates. If required, they can be pretreated before the adhesion-promoting pre-treatment composition are applied. Such pretreatments include especially physical and/or chemical cleaning methods, for example abrading, sandblasting, brushing or the like, or treatment with cleaners or solvents; or the application of an additional adhesion promoter, of an additional adhesion promoter solution or of a primer; or flaming or plasma treatment, especially an air plasma pretreatment at atmospheric ambient pressure.

More particularly, the substrate S1 is a mineral substrate, a plastic or a metallic substrate. A preferred mineral substrate is especially glass or glass ceramic, especially in the form of a pane.

Preferred plastics are especially polyvinyl chloride (PVC), polyurethanes, poly(meth)acrylates, especially in the form of a coating or paint.

A metallic substrate is understood here to mean metals, metal alloys and coated metals and metal alloys. Especially light metals, nonferrous metals and ferrous metals and the alloys thereof are suitable, such as aluminum, iron, copper, zinc, alloys thereof, especially brass and steel.

The adhesion-promoting pre-treatment composition can be applied by means of cloth, felt, roller, spraying, sponge, brush, dipcoating or the like, and can be either manually or by means of robots.

An adhesive can be applied to a substrate coated in this way with adhesion-promoting pre-treatment composition. In a further aspect, the invention therefore relates to a process for adhesive bonding of two substrates S1 and S2. There are different possibilities for this purpose: in a first variant, it comprises the following steps:
a) applying an adhesion-promoting pre-treatment composition as described previously to a first substrate S1 which in particular has a temperature of less than 5° C., especially of between 0° C. and −2° C., preferably of between −5° C. and −15° C.;
b) applying an adhesive to the flashed-off adhesion-promoting pre-treatment composition applied in step a);
c) contacting the adhesive with a second substrate S2.

In a second variant, it comprises the following steps:
a′) applying an adhesion-promoting pre-treatment composition as described above to a first substrate S1 which in particular has a temperature of less than 5° C., especially of between 0° C. and −20° C., preferably of between −5° C. and −15° C.;
b′) applying an adhesive or sealant to the surface of a second substrate S2
c′) contacting the adhesive with the flashed-off composition present on substrate S1.

In a third variant, it comprises the following steps:
a″) applying an adhesion-promoting pre-treatment composition as described above to a first substrate S1 and/or second substrate S2 which in particular has a temperature of less than 5° C., especially of between 0° C. and −20° C., preferably of between −5° C. and −15° C.;
b″) applying an adhesive to the first substrate S1 and second substrate S2, to at least one of which an adhesion-promoting pre-treatment composition has been applied in step a″);
c″) contacting the adhesives applied to one another to join the substrate parts to form an adhesive bond.

In a fourth variant, it comprises the following steps:
a′″) applying an adhesion-promoting pre-treatment composition as described above to a first substrate S1 which in particular has a temperature of less than 5° C., especially of between 0° C. and −20° C., preferably of between −5° C. and −15° C.;
b′″) flashing off the composition
c′″) applying an adhesive between the surfaces of substrates S1 and S2.

In all four of these, the second substrate S2 consists of the same or a different material than substrate S1.

The substrate S1 and/or S2 may be of various kinds. The possibilities for the second substrate S2 may be as described above for the substrate S1. More particularly, at least one of the substrates S1 or S2 is glass or glass ceramic. More particularly, one substrate is glass or glass ceramic, and the other substrate is a paint or a painted metal or a painted metal alloy. Therefore, the substrate S1 or S2 is glass or glass ceramic, and the substrate S2 or S1 is a paint or a painted metal or a painted metal alloy.

Step c), c′), c″ or c′″) is typically followed by a step d) of curing the adhesive. The person skilled in the art understands that, according to the system used and reactivity of the adhesive, crosslinking reactions, and hence curing already, can begin as early as during the application. However, the main part of the crosslinking and hence, in the narrower sense of the term, the curing takes place after the application, otherwise problems namely also arise with the buildup of adhesion to the substrate surface.

Usable adhesives are various adhesive systems. More particularly, they are moisture-curing adhesives based on prepolymers terminated with isocyanate groups and/or alkoxysilane.

Suitable adhesives based on alkoxysilane-terminated prepolymers are one-component moisture-curing adhesives, the so-called MS polymers or alkoxysilane-terminated polyurethane prepolymers, especially those as prepared from polyols and if required polyisocyanates with subsequent reaction of an isocyanate-reactive organosilane or an isocyanate-functional organosilane.

Suitable adhesives based on isocyanate-terminated prepolymers are understood to mean firstly two-component polyurethane adhesives whose first component comprises an amine or a polyol and whose second component comprises an NCO-containing prepolymer or a polyisocyanate. Examples of such two-component room temperature curing polyurethane adhesives are those from the SikaForce® product line, as commercially available from Sika Schweiz AG.

Suitable adhesives based on isocyanate-terminated prepolymers are additionally understood to mean reactive polyurethane hotmelt adhesives which comprise a thermoplastic polymer and an isocyanate-terminated prepolymer or a thermoplastic isocyanate-terminated prepolymer. Such reactive polyurethane hotmelt substances are melted and firstly solidify in the course of cooling and secondly crosslink through a reaction with air humidity.

Suitable adhesives based on isocyanate-terminated prepolymers are additionally understood to mean one-component moisture-curing polyurethane adhesives. Such adhesives or sealants crosslink under the influence of moisture, especially of air humidity. Examples of such one-component moisture-curing polyurethane adhesives are those from SikaFlex® and SikaTack® product lines, as commercially available from Sika Schweiz AG.

The abovementioned isocyanate-terminated prepolymers are prepared from polyols, especially polyoxyalkylenepolyols, and polyisocyanates, especially diisocyanates.

Preference is given to adhesives based on isocyanate-terminated prepolymers. Most preferred are one-component moisture-curing polyurethane adhesives based on isocyanate-terminated prepolymers.

It has been found that, especially in the case of moisture-curing polyurethane adhesives or sealants, a great improvement in adhesion can be achieved, in particular also at low temperatures, i.e., especially at a temperature of less than 5° C., especially at a temperature between 0° C. and −20° C., using the composition described. It is obvious that aqueous compositions, owing to ice formation, are likely to be unsuitable for application temperatures of less than 0° C.

These adhesion methods find use especially in the production of articles for industrial manufacture, especially of modes of transport. Such articles are especially automobiles, buses, trucks, rail vehicles, ships or aircraft.

The most preferred application is the glazing of modes of transport, especially of road and rail vehicles.

Owing to the excellent improvement in the adhesion of the adhesives and sealants at low temperatures, this process is suitable especially for glazing repairs, also called automotive glass repair (AGR) operations. Specifically, it is possible to glaze vehicles on the street on site, especially also in winter, without the vehicle first having to be put into a temperature-controlled garage. This is important in particular for repairs to vehicle panes in remote areas, especially where the roads frequently have loose stones or gravel. Such areas are frequently to be found, for example, in Scandinavia, Russia, China, Argentina, Chile, Canada or the USA. The adhesive undercoat composition is particularly suitable for a process for repairing glazing of a mode of transport, especially of an automobile, at an ambient temperature of less than 5° C., especially of between 0° C. and −20° C., preferably of between −5° C. and −15° C., comprising the steps of
i) removing the defective glass, especially a defective pane;
ii) applying an adhesion-promoting pre-treatment composition as described above to a piece of glass, especially pane, to be inserted by adhesive bonding, and/or to the flange of the mode of transport to be adhesively bonded;
iii) applying a moisture-curing one-component adhesive, especially a moisture-curing one-component polyurethane adhesive, which has a temperature between 10° C. and 80° C., especially about 23° C., to the piece of glass to be adhesive bonded and/or the flange of the mode of transport to be adhesively bonded;
iv) joining glass and flange via the adhesive present between them.

It has been found that, by means of this process, under cold conditions as frequently occur in winter, vehicles can be glazed on the street on site, without the vehicle first having to be put into a temperature-controlled garage. This is important in particular for repairs to vehicle panes in remote areas, especially where the streets frequently have loose stones or gravel. Such areas are frequently to found, for example, in Scandinavia, Russia, China, Argentina, Chile, Canada or the USA.

Since adhesion is also promoted by the adhesion-promoting pre-treatment composition according to the invention at higher temperatures, i.e., at temperatures of >5° C., typically about room temperature (23° C.) up to about 45° C. or higher, one and the same adhesion-promoting pre-treatment composition can be used, thus avoiding the necessity of a summer product and of a winter product or of a mode of operation which differs according to the season.

### EXAMPLES

The invention is elucidated further by the following examples, which are not intended to limit the invention in any way.

### Raw Materials Used

The following raw materials listed in Table 1 were used as commercially obtained without further purification or modification and employed in the process according to the invention to produce example adhesion-promoting pre-treatment compositions in order to demonstrate the effect of the invention.

TABLE 1
Raw materials used.

| | |
|---|---|
| Sil A-1110 | 3-Aminopropyltrimethoxysilane |
| | Silquest ® A1110, Momentive Performance Materials |
| Sil A-1120 | N-(2-Aminoethyl)-3-aminopropyltrimethoxysilane |
| | Silquest ® A1120, Momentive Performance Materials |
| Sil A-1170 | Bis(trimethoxysilylpropyl)amine |
| | Silquest ® A1170, Momentive Performance Materials |
| Sil A-189 | 3-Mercaptopropyltrimethoxysilane |
| | Silquest ® A189, Momentive Performance Materials |
| Sil A-187 | 3-Glycidoxypropyltrimethoxysilane |
| | Silquest ® A187, Momentive Performance Materials |
| Sil A-Link | Tris(3-(trimethoxysilyl)propyl)isocyanurate |
| | Silquest ® A-Link 597, Momentive Performance |
| | Materials |
| Dynasylan A | Tetraethylorthosilicate |
| | Dynasylan ® A, Evonik Industries |
| Tyzor IBAY | Diisobutoxy-bisethylacetoacetatotitanate |
| | Tyzor ® IBAY, Dorf Ketal |
| Tyzor TnBT | Tetra-n-butyl titanate |
| | Tyzor ® TnBT, Dorf Ketal |
| KR 9S | Tris(dodecylbenzenesulfanato-O)(propan-2-olato) |
| | titanium(IV) Ken-React ® KR 9S, Kenrich |
| | Petrochemicals |
| Tytan TNBZ | Tetra-n-butyl zirconate |
| | Tytan ® TNBZ, Borica Co. |
| Acetic acid | Acetic acid, 99% |
| MeSA | Methanesulfonic acid |
| Ethanol | solvent |
| Ethylal | Diethoxymethane; solvent |
| Acetone | solvent |
| Methyl acetate | solvent |
| Heptane | solvent |
| Water | Deionized water |
| Catalyst | Organotin-based silane condensation catalyst |

Production of the example compositions C1 to C22

Example compositions C1-C22 were produced using the following procedure's steps in consecutive order and involving the raw materials listed in Table 1. The respective composition details of each composition C1 to C22 are shown in Tables 2 to 5. In each table, the numbers denote the added amount (in weight parts) of each respective raw material/ingredient. Compositions not according to the invention are denoted with an asterisk (*) in Tables 2 to 5.

The process as follows was performed in a norm climate room (23° C., 50% r.h.) without heating of the reaction vessel.

### Step a)

An open glass beaker equipped with a magnetic stirrer was filled with the respective denoted amount of ethanol and, where applicable, further solvent.

### Step b)

All organosilane OS, organititanate OT, and/or organozirconate OZ raw materials were added stepwise under stirring, in the order and with the amount as listed in the respective Table 2 to 5 in each respective experiment.

### Step c)

Acid A was added, in the amount as listed in the respective Table 2 to 5 in each respective experiment.

### Step d)

Water was added, in the amount as listed in the respective Table 2 to 5 in each respective experiment.

### Step f)

The mixture obtained was left stirring for at least 30 min at 23° C., until a clear, homogeneous solution was obtained.

Each composition was then filled into sealable glass containers and used as adhesion-promoting pre-treatment for adhesion tests and/or in artificial ageing tests to assess storage stability.

TABLE 2
Ingredients (weight parts) added to compositions C1-C6.

| | C1 | C2 | C3 | C4 | C5 | C6 |
|---|---|---|---|---|---|---|
| Ethanol | 94 | 93.8 | 93.8 | 93.8 | 93 | 93 |
| Sil A-1170 | 2 | 2 | 2 | 2 | 2 | 2 |
| Sil A-Link | — | — | — | 0.2 | — | 0.5 |
| Sil A189 | — | — | — | — | — | — |
| Tyzor IBAY | — | 0.2 | — | — | — | — |
| Tyzor TnBT | — | — | 0.2 | — | 1 | 0.5 |
| Acetic Acid | 2 | 2 | 2 | 2 | 2 | 2 |
| Water | 2 | 2 | 2 | 2 | 2 | 2 |

*not according to invention.

TABLE 3
Ingredients (in weight parts) added to compositions C7-C12.

| | C7 | C8* | C9 | C10 | C11* | C12 |
|---|---|---|---|---|---|---|
| Ethanol | 90 | 90 | 91.9 | 89.9 | 89.9 | 89.9 |
| Sil A-1170 | 3 | 5 | 2 | 3 | 3 | 4 |
| Dynasylan A | — | — | — | — | 3 | — |
| Tyzor TnBT | 3 | 1 | 2 | 3 | — | 2 |
| Acetic Acid | 2 | 2 | 2 | 2 | 2 | 2 |
| Water | 2 | 2 | 2 | 2 | 2 | 2 |
| Catalyst | — | — | 0.1 | 0.1 | 0.1 | 0.1 |

*not according to invention.

TABLE 4
Ingredients (in weight parts) added to compositions C13-C17.

| | C13 | C14 | C15* | C16* | C17* |
|---|---|---|---|---|---|
| Ethanol | 89.7 | 89 | 69.9 | 69.9 | 69.9 |
| Ethylal | — | — | 20 | — | — |
| Acetone | — | — | — | 20 | — |
| Methyl acetate | — | — | — | — | 20 |
| Sil A-1170 | — | — | 3 | 3 | 3 |
| Sil A-1110 | 3.2 | — | — | — | — |
| Sil A-1120 | — | 3.9 | — | — | — |
| Tyzor TnBT | 3 | 3 | 3 | 3 | 3 |
| Acetic Acid | 2 | 2 | 2 | 2 | 2 |
| Water | 2 | 2 | 2 | 2 | 2 |
| Catalyst | 0.1 | 0.1 | 0.1 | 0.1 | 0.1 |

*not according to invention.

TABLE 5
Ingredients (in weight parts) added to compositions C18-C22.

| | C18 | C19 | C20* | C21 | C22 |
|---|---|---|---|---|---|
| Ethanol | 84.9 | 89.9 | 65.3 | 89.9 | 91.4 |
| Ethylal | 5 | — | — | — | — |
| Heptane | — | — | 25 | — | — |
| Sil A-1170 | 3 | 3 | 3 | 3 | 3 |
| Tyzor TnBT | 3 | 3 | 3 | — | — |
| KR 9S | — | — | — | — | 2 |
| Tytan TNBZ | — | — | — | 3 | — |
| Acetic Acid | 2 | 2 | 1.6 | 2 | 2 |
| MeSA | — | — | 0.4 | — | — |
| Water | 2 | 2 | 1.6 | 2 | 1.5 |
| Catalyst | 0.1 | 0.1 | 0.1 | 0.1 | 0.1 |

*not according to invention.

### Testing Protocols

The example compositions C1-022 was tested as follows.

In order to assess storage stability, the example compositions 01 to 022 were subjected to simulated ageing under heat. For this, a sealed glass bottle of each respective composition was placed into an oven (5000) and left for up to 2 years under this condition. Each week, the samples were checked for apparent changes (precipitation, gelation, etc.). For samples 011 to 022, no long-time data is available as they were produced more recently. Samples that showed no change in terms of gelation, precipitation, or other deterioration after at least 21 days at 50° C. are considered storage stable.

TABLE 6
Results of storage stability tests on compositions C1-C22.

| Composition | Storage stability test result |
|---|---|
| C1 | No changes in composition after 2 years at 50° C. |
| C2 | No changes in composition after 2 years at 50° C. |
| C3 | No changes in composition after 2 years at 50° C. |
| C4 | No changes in composition after 2 years at 50° C. |
| C5 | No changes in composition after 2 years at 50° C. |
| C6 | No changes in composition after 2 years at 50° C. |
| C7 | No changes in composition after 2 years at 50° C. |
| C8* | Gelled after 7 days at 50° C. |
| C9 | No changes in composition after 2 years at 50° C. |
| C10 | No changes in composition after 2 years at 50° C. |
| C11* | Gelled after 14 days at 50° C. |
| C12 | No changes in composition after >21 days at 50° C. |
| C13 | No changes in composition after >21 days at 50° C. |
| C14 | No changes in composition after >21 days at 50° C. |
| C15* | Gelled after 7 days at 50° C. |
| C16* | Gelled after 7 days at 50° C. |
| C17* | Gelled after 21 days at 50° C. |
| C18 | No changes in composition after >21 days at 50° C. |
| C19 | No changes in composition after >21 days at 50° C. |
| C20* | Gelled after 7 days at 50° C. |
| C21 | No changes in composition after >21 days at 50° C. |
| C22 | No changes in composition after >21 days at 50° C. |

*not according to invention

### Adhesion Test Protocol

This test protocol investigates the adhesion-promoting capabilities of example compositions prepared with the process as specified above, both including examples according to the invention and reference examples not according to the invention, and additionally of two commercial solvent-based activators as reference of the state of the art.

The adhesive used in this test protocol was SikaTack® ELITE, which is a commercially available one-component moisture-curing polyurethane adhesive which contains polyurethane prepolymers having isocyanate groups and is commercially available from Sika Schweiz AG.

The additional reference adhesion-promoting pre-treatments (currently used activators of the state of the art) used were:
“MP-A”, a multipurpose solvent-based activator especially suited for glass and ceramic substrates (“MP-A”), and
“AGR-A” a solvent-based activator optimized for AGR applications, including low temperature glass replacement (“AGR-A”).

Both reference activators MP-A and AGR-A were prepared by adding the respective silanes to the respective solvents. The detailed ingredients and their amount, in weight parts, are shown in the following table 7:

TABLE 7
Ingredients (in weight parts) added to reference
activator compositions MP-A and AGR-A.

| | MP-A * | AGR-A * |
|---|---|---|
| Heptane | 93.9 | 80.8 |
| Ethanol | — | 15.0 |
| Sil A-1170 | 6.0 | 4.0 |
| Sil A-189 | 0.1 | — |
| Sil A-187 | — | 0.2 |

* not according to invention.

The substrates used were: “Glass (air)”: float glass in which the air side was used for adhesion testing, Rocholl, Germany; “Glass (tin)”: float glass in which the tin side was used for adhesion testing, Rocholl, Germany; “Frit 3402”: ESG ceramic, Ferro AD 3402, Rocholl, Germany; “Ferro 14279”: VSG ceramic, Ferro 14279, Rocholl, Germany; “Ferro 14303”: VSG ceramic, Ferro 14303 IR7134, Rocholl, Germany.

All substrate faces were cleaned immediately prior to the application of the adhesion promoter compositions by wiping-off by means of a cellulose cloth (Tela®) that had been soaked with an isopropanol and flashed off for at least 2 minutes prior to the application of the respective adhesion-promoting pre-treatment composition to be tested.

The compositions to be tested were applied to the particular substrate by means of a cellulose cloth soaked therewith (Tela®, Tela-Kimberly Switzerland GmbH) and left during a flash-off time of 5 min before the adhesive was applied on the thus pre-treated surface (“wipe-on” application). The substrate was in most cases conditioned at 23° C. before application of the composition, but in some cases at 5° C. instead to study the low temperature application behavior. The exact application conditions are shown in Tables 7 to 11 for each experiment.

A triangular bead of the adhesive was applied by means of expression cartridge and nozzle at 23±2° C. and 50% rel. air humidity. The adhesive itself was equilibrated in a closed cartridge at 23° C. for 24 h prior to application.

The cured bond with the adhesive was tested after a curing time as specified in each experiment (Tables 7 to 11) for between 45 min and 7 days under controlled climatic conditions (23° C., 50% rel. air humidity) (e.g., “45 min RT”), or cured immersed in water for 7 days to assess water-stability of the adhesive bond (“7 d water”).

The adhesion of the adhesive was tested by means of the ‘bead adhesion test’. This involves cutting into the bead at its end just above the bond surface. The cut end of the bead is held with round-nose pliers and pulled away from the substrate. This is done by cautiously rolling up the bead onto the tip of the pliers and making a cut at right angles to the bead pulling direction down to the bare substrate. The bead pulling speed should be chosen such that a cut has to be made about every 3 seconds. The test distance must correspond to at least 8 cm. What is assessed is the adhesive remaining on the substrate after the bead has been pulled away (cohesion fracture). The adhesion properties are assessed by visual determination of the cohesive fraction of the bonding area.

In this test protocol, the amount of cohesive failure (in % based on the whole fracture pattern) was assessed and expressed in numbers (0% CF to 100% CF, wherein “CF” stands for “cohesive failure”).

The higher the proportion of cohesive fracture, the better the assessment of the adhesive bond. Ideally, an adhesion shows 100% CF.

The results of these adhesion tests are shown for the tested adhesion-promoting pre-treatment compositions on the individual test substrates in Tables 8 to 12.

TABLE 8
Adhesion test results of test protocol.

| Test conditions (flash-off | | | | | | | | |
|---|---|---|---|---|---|---|---|---|
| time 5 min/23° C.) | | | | | | | | |
| | Applica- | | | | | | | |
| | tion | | Adhesion of test | | | | | |
| | temper- | Curing | composition | | | | | |
| Substrate | ature | time | MP-A* | | C1 | | C5 | |
| Ferro 14279 | 23° C. | 7 d RT | 50% | CF | 50% | CF | 80% | CF |
| Frit 3402 | 23° C. | 7 d RT | 0% | CF | 0% | CF | 0% | CF |
| Ferro 14303 | 23° C. | 7 d RT | 100% | CF | 100% | CF | 100% | CF |
| Glass tin | 23° C. | 7 d RT | 0% | CF | 0% | CF | 100% | CF |
| Glass air | 23° C. | 7 d RT | 100% | CF | 100% | CF | 100% | CF |
| Ferro 14279 | 23° C. | 7 d water | 0% | CF | 100% | CF | 100% | CF |
| Frit 3402 | 23° C. | 7 d water | 0% | CF | 0% | CF | 80% | CF |
| Ferro 14303 | 23° C. | 7 d water | 100% | CF | 100% | CF | 100% | CF |
| Glass tin | 23° C. | 7 d water | 0% | CF | 0% | CF | 100% | CF |
| Glass air | 23° C. | 7 d water | 100% | CF | 100% | CF | 100% | CF |

*not according to invention.

TABLE 9
Adhesion test results of test protocol.

| Test conditions (flash-off | | | | | | | |
|---|---|---|---|---|---|---|---|
| time 5 min/23° C.) | | | | | | | |
| | Applica- | | | | | | |
| | tion | | Adhesion of test | | | | |
| | temper- | Curing | composition | | | | |
| Substrate | ature | time | C11* | | C9 | C8* | |
| Ferro 14279 | 23° C. | 45 min RT | 0% | CF | 100% CF | 0% | CF |
| Frit 3402 | 23° C. | 45 min RT | 0% | CF | 100% CF | 0% | CF |
| Ferro 14303 | 23° C. | 45 min RT | 0% | CF | 100% CF | 0% | CF |
| Glass tin | 23° C. | 45 min RT | 50% | CF | 100% CF | 0% | CF |
| Glass air | 23° C. | 45 min RT | 50% | CF | 100% CF | 0% | CF |
| Ferro 14279 | 23° C. | 7 d water | 50% | CF | 100% CF | 100% | CF |
| Frit 3402 | 23° C. | 7 d water | 0% | CF | 100% CF | 50% | CF |
| Ferro 14303 | 23° C. | 7 d water | 50% | CF | 100% CF | 100% | CF |
| Glass tin | 23° C. | 7 d water | 0% | CF | 100% CF | 0% | CF |
| Glass air | 23° C. | 7 d water | 100% | CF | 100% CF | 100% | CF |

*not according to invention.

TABLE 10
Adhesion test results of test protocol.

| Test conditions (flash-off | | | | | | | | |
|---|---|---|---|---|---|---|---|---|
| time 5 min/23° C.) | | | | | | | | |
| | Applica- | | | | | | | |
| | tion | | Adhesion of test | | | | | |
| | temper- | Curing | composition | | | | | |
| Substrate | ature | time | C9 | | C12 | | MP-A* | |
| Ferro 14279 | 23° C. | 1 h RT | 100% | CF | 100% | CF | 100% | CF |
| Frit 3402 | 23° C. | 1 h RT | 100% | CF | 100% | CF | 100% | CF |
| Ferro 14303 | 23° C. | 1 h RT | 100% | CF | 100% | CF | 100% | CF |
| Glass tin | 23° C. | 1 h RT | 100% | CF | 100% | CF | 50% | CF |
| Glass air | 23° C. | 1 h RT | 100% | CF | 100% | CF | 100% | CF |
| Ferro 14279 | 23° C. | 6 h RT | 100% | CF | 100% | CF | 100% | CF |
| Frit 3402 | 23° C. | 6 h RT | 10% | CF | 70% | CF | 100% | CF |
| Ferro 14303 | 23° C. | 6 h RT | 100% | CF | 100% | CF | 100% | CF |
| Glass tin | 23° C. | 6 h RT | 100% | CF | 100% | CF | 0% | CF |
| Glass air | 23° C. | 6 h RT | 100% | CF | 100% | CF | 100% | CF |
| Ferro 14279 | 23° C. | 7 d RT | 100% | CF | 100% | CF | 100% | CF |
| Frit 3402 | 23° C. | 7 d RT | 100% | CF | 100% | CF | 100% | CF |
| Ferro 14303 | 23° C. | 7 d RT | 100% | CF | 100% | CF | 100% | CF |
| Glass tin | 23° C. | 7 d RT | 100% | CF | 100% | CF | 0% | CF |
| Glass air | 23° C. | 7 d RT | 100% | CF | 100% | CF | 100% | CF |
| Ferro 14279 | 23° C. | 7 d water | 100% | CF | 100% | CF | 100% | CF |
| Frit 3402 | 23° C. | 7 d water | 100% | CF | 60% | CF | 0% | CF |
| Ferro 14303 | 23° C. | 7 d water | 100% | CF | 100% | CF | 100% | CF |
| Glass tin | 23° C. | 7 d water | 100% | CF | 100% | CF | 0% | CF |
| Glass air | 23° C. | 7 d water | 100% | CF | 100% | CF | 100% | CF |

*not according to invention.

Tables 8 to 10 show that the compositions according to the invention show an improved adhesion-promoting effect on the tested substrates compared to similar compositions not according to the invention. Compared to commercial benchmark activators (MP-A), the compositions according to the invention perform at least equal if not better under ambient curing conditions. Regarding the adhesion results underwater, the compositions according to the invention clearly possess improved properties compared to the commercial activators.

TABLE 11
Adhesion test results of test protocol.

| Test conditions (flash-off | | | | | | | |
|---|---|---|---|---|---|---|---|
| time 5 min/23° C.) | | | | | | | |
| | Applica- | | | | | | |
| | tion | | Adhesion of test | | | | |
| | temper- | Curing | composition | | | | |
| Substrate | ature | time | AGR-A* | | C10 | C11* | |
| Ferro 14279 | 23° C. | 1 h RT | 100% | CF | 100% CF | 50% | CF |
| Frit 3402 | 23° C. | 1 h RT | 100% | CF | 100% CF | 50% | CF |
| Glass tin | 23° C. | 1 h RT | 100% | CF | 100% CF | 100% | CF |
| Glass air | 23° C. | 1 h RT | 100% | CF | 100% CF | 100% | CF |
| Ferro 14279 | 23° C. | 6 h RT | 100% | CF | 100% CF | 100% | CF |
| Frit 3402 | 23° C. | 6 h RT | 100% | CF | 100% CF | 100% | CF |
| Glass tin | 23° C. | 6 h RT | 10% | CF | 100% CF | 100% | CF |
| Glass air | 23° C. | 6 h RT | 100% | CF | 100% CF | 100% | CF |
| Ferro 14279 | 23° C. | 7 d RT | 100% | CF | 100% CF | 0% | CF |
| Frit 3402 | 23° C. | 7 d RT | 100% | CF | 100% CF | 0% | CF |
| Glass tin | 23° C. | 7 d RT | 100% | CF | 100% CF | 0% | CF |
| Glass air | 23° C. | 7 d RT | 100% | CF | 100% CF | 100% | CF |
| Ferro 14279 | 23° C. | 7 d water | 100% | CF | 100% CF | 50% | CF |
| Frit 3402 | 23° C. | 7 d water | 0% | CF | 100% CF | 0% | CF |
| Glass tin | 23° C. | 7 d water | 50% | CF | 100% CF | 0% | CF |
| Glass air | 23° C. | 7 d water | 100% | CF | 100% CF | 100% | CF |

*not according to invention.

The results in Table 11 confirm that the example composition C10 according to the invention leads to exceptional adhesion both at short (1 h) or long (7 d) curing time, compared to commercial (AGR-A) and example (C11) reference compositions. The inventive composition is again superior especially in water-resistance of the adhesive bond.

TABLE 12
Adhesion test results of test protocol.

| Test conditions (flash-off | | | | | | | | |
|---|---|---|---|---|---|---|---|---|
| time 5 min/23° C.) | | | | | | | | |
| | Applica- | | | | | | | |
| | tion | | Adhesion of test | | | | | |
| | temper- | Curing | composition | | | | | |
| Substrate | ature | time | MP-A* | | AGR-A* | | C12 | |
| Ferro 14279 | 5° C. | 2 h RT | 0% | CF | 100% | CF | 100% | CF |
| Frit 3402 | 5° C. | 2 h RT | 100% | CF | 100% | CF | 100% | CF |
| Ferro 14303 | 5° C. | 2 h RT | 100% | CF | 100% | CF | 100% | CF |
| Glass tin | 5° C. | 2 h RT | 0% | CF | 0% | CF | 100% | CF |
| Glass air | 5° C. | 2 h RT | 100% | CF | 100% | CF | 100% | CF |
| Ferro 14279 | 5° C. | 24 h RT | 0% | CF | 100% | CF | 100% | CF |
| Frit 3402 | 5° C. | 24 h RT | 100% | CF | 100% | CF | 100% | CF |
| Ferro 14303 | 5° C. | 24 h RT | 100% | CF | 100% | CF | 100% | CF |
| Glass tin | 5° C. | 24 h RT | 0% | CF | 50% | CF | 95% | CF |
| Glass air | 5° C. | 24 h RT | 100% | CF | 100% | CF | 100% | CF |
| Ferro 14279 | 5° C. | 7 d RT | 0% | CF | 100% | CF | 100% | CF |
| Frit 3402 | 5° C. | 7 d RT | 100% | CF | 100% | CF | 100% | CF |
| Ferro 14303 | 5° C. | 7 d RT | 0% | CF | 100% | CF | 100% | CF |
| Glass tin | 5° C. | 7 d RT | 0% | CF | 50% | CF | 50% | CF |
| Glass air | 5° C. | 7 d RT | 100% | CF | 100% | CF | 100% | CF |
| Ferro 14279 | 5° C. | 7 d water | 0% | CF | 100% | CF | 100% | CF |
| Frit 3402 | 5° C. | 7 d water | 100% | CF | 0% | CF | 100% | CF |
| Ferro 14303 | 5° C. | 7 d water | 100% | CF | 100% | CF | 100% | CF |
| Glass tin | 5° C. | 7 d water | 0% | CF | 100% | CF | 20% | CF |
| Glass air | 5° C. | 7 d water | 100% | CF | 100% | CF | 100% | CF |

*not according to invention.

Table 12 compares an inventive composition (012) to two commercial activators regarding their low-temperature application. As can be seen, composition according to the invention even slightly exceeds the performance of AGR-A, an activator optimized for AGR applications independent of the temperature.

Adhesion Tests with Aged Adhesion-Promoting Pre-Treatment Compositions

Additional adhesion tests were performed using example composition 010 (one sample freshly prepared and one sample aged by leaving the bottle open for 40 minutes at 35° C. and 80% r.h.). As reference, AGR-A (see above) was used, also employing both a fresh sample and an in the same way artificially aged sample.

These adhesion tests were done on the following samples: “Glass (air)”: float glass in which the air side was used for adhesion testing, Rocholl, Germany; “Glass (tin)”: float glass in which the tin side was used for adhesion testing, Rocholl, Germany.

The adhesive used was SikaTack® PRO, a one-component polyurethane adhesive for AGR applications that is available from Sika Schweiz.

The adhesion tests were performed in the same manner as described above for the first adhesion test protocol. Additionally, adhesion tests after curing of the adhesive bond for 1 day at 80° C. in the oven (“1 d 80° C.”) were done.

The results are shown in Table 13.

TABLE 13
Adhesion test results of test protocol.

| Test conditions (flash-off | | | | | |
|---|---|---|---|---|---|
| time 3 min/23° C.) | | | | Adhesion of test | |
| | Application | | Curing | composition | |
| Substrate | temperature | | time | AGR-A* | C10 |
| | | | | fresh samples | |
| Glass tin | 23° | C. | 7 d RT | 100% CF | 100% CF |
| Glass air | 23° | C. | 7 d RT | 100% CF | 100% CF |
| Glass tin | 23° | C. | 7 d water | 40% CF | 100% CF |
| Glass air | 23° | C. | 7 d water | 100% CF | 100% CF |
| Glass tin | 23° | C. | 1 d 80° C. | 100% CF | 100% CF |
| Glass air | 23° | C. | 1 d 80° C. | 100% CF | 100% CF |
| Glass tin | 5° | C. | 7 d RT | 0% CF | 100% CF |
| Glass air | 5° | C. | 7 d RT | 100% CF | 100% CF |
| Glass tin | 5° | C. | 7 d water | 100% CF | 100% CF |
| Glass air | 5° | C. | 7 d water | 100% CF | 100% CF |
| Glass tin | 5° | C. | 1 d 80° C. | 0% CF | 100% CF |
| Glass air | 5° | C. | 1 d 80° C. | 100% CF | 100% CF |
| | | | | aged samples | |
| Glass tin | 23° | C. | 7 d RT | 5% CF | 100% CF |
| Glass air | 23° | C. | 7 d RT | 100% CF | 100% CF |
| Glass tin | 23° | C. | 7 d water | 0% CF | 100% CF |
| Glass air | 23° | C. | 7 d water | 100% CF | 100% CF |
| Glass tin | 23° | C. | 1 d 80° C. | 75% CF | 100% CF |
| Glass air | 23° | C. | 1 d 80° C. | 100% CF | 100% CF |
| Glass tin | 5° | C. | 7 d RT | 5% CF | 100% CF |
| Glass air | 5° | C. | 7 d RT | 100% CF | 100% CF |
| Glass tin | 5° | C. | 7 d water | 0% CF | 100% CF |
| Glass air | 5° | C. | 7 d water | 100% CF | 100% CF |
| Glass tin | 5° | C. | 1 d 80° C. | 100% CF | 100% CF |
| Glass air | 5° | C. | 1 d 80° C. | 100% CF | 95% CF |

*not according to invention.

The results shown in Table 13 confirm that the inventive composition does not lose its performance after ageing and shows the same adhesion-promoting effect as in the fresh state, regardless of application temperature and curing conditions of the adhesive bond. The reference compositions on the other hand shows some loss of performance after artificial ageing.

1. A process for preparing an adhesion-promoting pre-treatment composition, comprising the steps:
a) providing a reaction vessel containing 100 parts by weight of an alcohol having 1 to 4 carbon atoms;
b) adding at least one organosilane in an amount that between 0.15 and 0.8 parts by weight of silicon are added and adding at least one organoitianate in an amount that between 0.01 and 0.8 parts by weight of titanium are added and adding at least one organozirconate in an amount that between 0.01 and 0.8 parts by weight of zirconium are added;
c) adding an acid in an amount that the resulting pH is between 3.5 and 7;
d) adding water, wherein the amount of water added is at least equimolar to or in a molar excess to the molar amount of hydrolyzable silicon-, titanium-, and or zirconium-bound groups present in all added organosilane, organoitianate, and organozirconate, wherein the amount of water is at most 25 parts per weight;
e) adding further additives selected from colorants, UV markers, condensation catalysts, or stabilizers;
f) waiting, under stirring, shaking, and/or heating, until all hydrolyzable groups present in all added organosilane, organoitianate, and organozirconate are hydrolyzed.

2. The process as claimed in claim 1, wherein the acid in step c) is a carboxylic acid or an alkylsulfonic acid.

3. The process as claimed in claim 1, wherein organosilane comprises at least one organosilane or condensate thereof that has at least one Si-bonded hydrolyzable group and has at least one primary and/or secondary amino group.

4. The process as claimed in claim 1, wherein organosilane comprises organosilanes or oligomers of these organosilanes that have at least one Si-bonded hydrolyzable group and have at least one further functional group bound to the Silicon atom via at least one carbon atom and optionally ether oxygen or nitrogen atoms, the functional group selected from alkyl groups, alkylene groups, phenyl groups, epoxy groups, mercapto groups, hydroxyl groups, (meth)acrylate groups, isocyanate groups, anhydride groups, silane groups, and isocyanurate groups.

5. The process as claimed in claim 1, wherein organotitanate is a tetraalkoxytitanate.

6. The process as claimed in claim 1, wherein organozirconate is a tetraalkoxyzirconate.

7. The process as claimed in claim 1, wherein the alcohol having 1 to 4 carbon atoms is ethanol.

8. The process as claimed in claim 1, wherein acid is added in step c) in an amount that the resulting pH is between 4 and 6.5.

9. The process as claimed in claim 1, wherein the amount of water added in step d) is between 0.3% and 15% by weight, based on the total composition after step d).

10. The process as claimed in claim 1, wherein in step e), a silane condensation catalyst is added.

11. The process as claimed in claim 1, wherein the composition after step e) comprises, based on the total composition:
between 80% and 95% by weight of the alcohol;
between 1% and 3.5% by weight of organosilane;
between 1% and 3.5% by weight of organotitanate;
between 0.3% and 2% by weight of acid;
between 0.3% and 15% by weight of water; and
between 0.01% and 0.2% of a silane condensation catalyst;
wherein organosilane and organotitanate may be partially or fully hydrolyzed by the water in the composition.

12. An adhesion-promoting pre-treatment composition obtained from a process as claimed in claim 1, wherein all added organosilanes and added organotitanates and added organozirconates are fully hydrolyzed.

13. A process for bonding substrates, the process comprising treating at least one of the substrates with the adhesion-promoting pre-treatment composition as claimed in claim 12 as adhesion promoter or activator.

14. The process as claimed in claim 13, wherein at least one of the substrates treated with the adhesion-promoting pre-treatment composition is a glass or glass ceramic substrate.

15. The process as claimed in claim 13, further comprising applying a polyurethane adhesive or an adhesive based on silane-functional polymers to at least one of the substrates.
